(19) United States
(12) Patent Application Publication
(10) Pub. No.: US 2023/0186648 A1
(43) Pub. Date: Jun. 15, 2023

(54) VEHICLE LIDAR SYSTEM AND OBJECT DETECTION METHOD THEREOF

(71) Applicants: HYUNDAI MOTOR COMPANY, Seoul (KR); KIA CORPORATION, Seoul (KR)

(72) Inventors: Ju Hyeok Ra, Guri-si (KR); Hyun Ju Kim, Yongin-si (KR)

(73) Assignees: Hyundai Motor Company, Seoul (KR); KIA CORPORATION, Seoul (KR)

(21) Appl. No.: 17/983,771

(22) Filed: Nov. 9, 2022

(30) Foreign Application Priority Data
Dec. 9, 2021 (KR) 10-2021-0175936

(51) Int. Cl. G06V 20/56; G01S 17/89

(52) U.S. Cl. CPC G06V 20/588; G01S 17/89

(57) ABSTRACT

An object detection method of a vehicle LiDAR system includes setting grids including a host vehicle lane according to a lane width on a grid map which is generated based on freespace point data and object information, and calculating a road boundary candidate based on occupation percentages of objects by lane calculated based on the object information and distributions of the freespace point data; and outputting road boundary information by correcting the calculated road boundary candidate based on information on a road boundary candidate determined at a previous time point.

The present application claims the benefit of priority to Korean Patent Application No. 10-2021-0175936, filed on Dec. 9, 2021 in the Korean Intellectual Property Office, which is hereby incorporated by reference as if fully set forth herein.

### TECHNICAL FIELD

Embodiments of the present disclosure relate to a vehicle LiDAR system and an object detection method thereof.

### BACKGROUND

A Light Detection And Ranging (LiDAR) has been developed in the form of constructing topographic data for constructing three-dimensional geographic information system (GIS) information and visualizing the topographic data. A LiDAR system may obtain information on a surrounding object, such as a target vehicle, by using a LiDAR sensor, and may assist in the autonomous driving function of a vehicle equipped with the LiDAR sensor (hereinafter referred to as a ‘host vehicle’), by using the obtained information.

If information on an object recognized using the LiDAR sensor is inaccurate, the reliability of autonomous driving may decrease, and the safety of a driver may be jeopardized. Thus, research to improve the accuracy of detecting an object has continued.

### SUMMARY

Embodiments provide a vehicle LiDAR system and an object detection method thereof, capable of accurately detecting boundaries of a road on which a vehicle is traveling.

It is to be understood that technical objects to be achieved by embodiments are not limited to the aforementioned technical objects and other technical objects which are not mentioned herein will be apparent from the following description to one of ordinary skill in the art to which the present disclosure pertains.

To achieve the objects and other advantages and in accordance with the purpose of the present disclosure, an object detection method of a vehicle LiDAR system may include: setting grids including a host vehicle lane according to a lane width on a grid map which is generated based on freespace point data and object information, and calculating a road boundary candidate based on occupation percentages of objects by lane calculated based on the object information and distributions of the freespace point data; and outputting road boundary information by correcting the calculated road boundary candidate based on information on a road boundary candidate determined at a previous time point.

In one embodiment, the calculating of the road boundary candidate may include: extracting point data of a region-of-interest from the freespace point data; deleting points which are not matched to an object, among the extracted point data in the region-of-interest; and generating the grid map based on freespace point data remaining after deleting the points which are not matched to the object.

In one embodiment, the calculating of the road boundary candidate may include: selecting a road boundary lane candidate by setting lane grids including the host vehicle lane according to the lane width on the grid map; and selecting the road boundary candidate by setting freespace grids which are obtained by dividing a lane selected as the road boundary lane candidate by ‘n’ (‘n’ is a natural number).

In one embodiment, the selecting of the road boundary lane candidate may include: matching object tracking channels to each lane grid of the lane grids; calculating a ratio of a length occupied by objects to an overall length of each lane grid; calculating a ratio of a length occupied by static objects to the length occupied by the objects, for a lane grid in which the ratio of the length occupied by the objects is equal to or greater than a first reference; and selecting a corresponding lane grid from the lane grids as the road boundary lane candidate when the ratio of the length occupied by the static objects to the length occupied by the objects is equal to or greater than a second reference.

In one embodiment, the calculating of the ratio of the length occupied by objects to the overall length of the lane grid may include: assigning different weights to a grid occupied by a static object and a grid occupied by a moving object, respectively, for longitudinal grids set in the lane grid, and summing values of grids occupied by the objects; and calculating a percentage of a value obtained by summing the values of the grids occupied by the objects to a total number of longitudinal grids set in the lane grid.

In one embodiment, the selecting of the road boundary lane candidate may include: moving a position of the lane grid in left and right directions; calculating a ratio of a length occupied by static objects to a length occupied by objects based on the moved lane grid; and calculating a ratio of a length occupied by static objects calculated based on the moved lane grid to a length occupied by static objects calculated before the lane grid is moved, and when the ratio of the length occupied by the static objects is equal to or greater than a third reference, selecting the corresponding lane grid as the road boundary lane candidate.

In one embodiment, the selecting of the road boundary candidate may include: setting freespace grids by dividing a lane grid of the lane selected as the road boundary lane candidate by 3; measuring the number of freespace point data belonging to each freespace grid of the set freespace grids; and selecting a freespace grid of which the measured number of freespace point data is equal to or greater than a threshold, as the road boundary candidate.

In one embodiment, the outputting of the road boundary information may include: calculating a predicted value of a road boundary at a current time point by reflecting a lateral speed of the host vehicle on the information on the road boundary candidate determined at the previous time point; selecting left and right freespace grids adjacent to the host vehicle among road boundary candidates; and outputting the road boundary information by correcting the selected freespace grids according to the predicted value.

In one embodiment, the object detection method may further include initializing the road boundary information when the corrected road boundary invades the host vehicle lane or there is no static object at a position of the corrected road boundary.

In one embodiment, the object detection method may further include obtaining, by a LiDAR sensor, the freespace point data and the object information before the setting of the grids.

In another embodiment, a computer-readable recording medium may store a program for executing an object detection method of a vehicle LiDAR system, in which execution of the program causes a processor to: set grids including a host vehicle lane according to a lane width on a grid map which is generated based on freespace point data and object information, and calculate a road boundary candidate based on occupation percentages of objects by lane calculated based on the object information and distributions of the freespace point data; and output road boundary information by correcting the calculated road boundary candidate based on information on a road boundary candidate determined at a previous time point.

In still another embodiment, a vehicle LiDAR system may include: a LiDAR sensor configured to obtain freespace point data and object information; and a LiDAR signal processing device configured to set grids including a host vehicle lane according to a lane width on a grid map which is generated based on the freespace point data and the object information obtained through the LiDAR sensor, to calculate a road boundary candidate based on occupation percentages of objects by lane calculated based on the object information and distributions of the freespace point data, and to output road boundary information by correcting the calculated road boundary candidate based on information on a road boundary candidate determined at a previous time point.

In one embodiment, The LiDAR signal processing device may include: a point extraction unit configured to extract point data of a region-of-interest from the freespace point data, and to delete points which are not matched to an object, among the extracted point data in the region-of-interest; and a grid map generation unit configured to generate the grid map based on freespace point data remaining after deleting the points which are not matched to the object.

In one embodiment, the LiDAR signal processing device may include: a road boundary selection unit configured to select a road boundary lane candidate by setting lane grids including the host vehicle lane according to the lane width on the grid map, and to select the road boundary candidate by setting freespace grids which are obtained by dividing a lane selected as the road boundary lane candidate by ‘n’ (‘n’ is a natural number).

In one embodiment, the road boundary selection unit may match object tracking channels to each lane grid of the lane grids, may calculate a ratio of a length occupied by objects to an overall length of each lane grid, may calculate a ratio of a length occupied by static objects to the length occupied by the objects, for a lane grid in which the ratio of the length occupied by the objects is equal to or greater than a first reference, and may select a corresponding lane grid from the lane grids as the road boundary lane candidate when the ratio of the length occupied by the static objects to the length occupied by the objects is equal to or greater than a second reference.

In one embodiment, the road boundary selection unit may assign different weights to a grid occupied by a static object and a grid occupied by a moving object, respectively, for longitudinal grids set in the lane grid, may sum values of grids occupied by the objects, and may calculate a percentage of a value obtained by summing the values of the grids occupied by the objects to a total number of longitudinal grids set in the lane grid.

In one embodiment, the road boundary selection unit may move a position of the lane grid in left and right directions, may calculate a ratio of a length occupied by static objects to a length occupied by objects based on the moved lane grid, may calculate a ratio of a length occupied by static objects calculated based on the moved lane grid to a length occupied by static objects calculated before the lane grid is moved, and when the ratio of the length occupied by the static objects is equal to or greater than a third reference, may selects the corresponding lane grid as the road boundary lane candidate.

In one embodiment, the road boundary selection unit may set freespace grids by dividing a lane grid of the lane selected as the road boundary lane candidate by 3, may measure the number of freespace point data belonging to each freespace grid of the freespace grids set by the road boundary selection unit, and may select a freespace grid of which the measured number of freespace point data is equal to or greater than a threshold, as the road boundary candidate.

In one embodiment, the vehicle LiDAR system may further include: a correction unit configured to calculate a predicted value of a road boundary at a current time point by reflecting a lateral speed of the host vehicle on the information on the road boundary candidate determined at the previous time point, to select left and right freespace grids adjacent to the host vehicle among road boundary candidates, and to output the road boundary information by correcting the selected freespace grids according to the predicted value.

In one embodiment, the vehicle LiDAR system may further include a postprocessing unit configured to initialize the road boundary information when the corrected road boundary invades the host vehicle lane or there is no static object at a position of the corrected road boundary.

In the vehicle LiDAR system and the object detection method thereof according to the embodiments, by determining boundary position information of a road by using freespace point data and object information, an error occurring when detecting an object of a road boundary region, due to point noise according to screening by a moving object, a reflection distance and an angle, may be reduced, whereby it is possible to accurately detect boundaries of a road.

Effects obtainable from the embodiments may not be limited by the above mentioned effects. Other unmentioned effects may be clearly understood from the following description by those having ordinary skill in the technical field to which the present disclosure pertains.

### BRIEF DESCRIPTION OF THE DRAWINGS

The accompanying drawings, which are included to provide a further understanding of the disclosure and are incorporated in and constitute a part of this application, illustrate embodiment(s) of the present disclosure and together with the description serve to explain the principle of the disclosure. In the drawings:

FIG. 1 is a control block diagram of a vehicle LiDAR system according to an embodiment of the present disclosure;

FIG. 2 is a flowchart of an object detection method of a vehicle LiDAR system according to an embodiment of the present disclosure;

FIGS. 3A, 3B and 3C are diagrams for explaining a grid map generation method according to an embodiment of the present disclosure;

FIGS. 4 and 5 are diagrams for explaining a grid setting method for selecting a road boundary lane candidate according to an embodiment of the present disclosure;

FIGS. 6 and 7 are diagrams for explaining a road boundary lane candidate selection method according to an embodiment of the present disclosure;

FIGS. 8 and 9 are diagrams for explaining a road boundary selection method according to an embodiment of the present disclosure;

FIGS. 10 and 11 are diagrams showing a result of simulating a road boundary detection method according to an embodiment of the present disclosure;

FIG. 12 is a flowchart of a lateral correction method for road boundary selection according to an embodiment of the present disclosure;

FIG. 13 is a diagram showing road boundaries finally determined as a result of lateral correction of FIG. 12; and

FIGS. 14 and 15 are diagrams showing simulation results according to comparative examples and embodiments.

### DETAILED DESCRIPTION

Hereinafter, embodiments will be described in detail with reference to the annexed drawings and description. However, the embodiments set forth herein may be variously modified, and it should be understood that there is no intent to limit embodiments to the particular forms disclosed, but on the contrary, the embodiments are to cover all modifications, equivalents, and alternatives falling within the spirit and scope of embodiments as defined by the claims. The embodiments are provided to more completely describe embodiments to those skilled in the art.

In the following description of the embodiments, it will be understood that, when each element is referred to as being formed “on” or “under” the other element, it can be directly “on” or “under” the other element or can be indirectly formed with one or more intervening elements therebetween.

Further, when an element is referred to as being formed “on” or “under” another element, not only the upward direction of the former element but also the downward direction of the former element may be included.

In addition, it will be understood that, although relational terms, such as “first”, “second”, “upper”, “lower”, etc., may be used herein to describe various elements, these terms neither require nor connote any physical or logical relations between substances or elements or the order thereof, and are used only to discriminate one substance or element from other substances or elements.

Throughout the specification, when an element “includes” a component, this may indicate that the element does not exclude another component unless stated to the contrary, but can further include another component. In the drawings, parts irrelevant to the description are omitted in order to clearly describe embodiments, and like reference numerals designate like parts throughout the specification.

According to the present embodiment, when detecting an object using a LiDAR (Light Detecting And Ranging) sensor, a method of determining the positions of left and right boundaries of a road on which a host vehicle (which refers to a vehicle to be controlled, e.g., an own vehicle, and/or a vehicle equipped with a LiDAR system) is traveling, by using the point information of a freespace and information on the object, is suggested. Accordingly, it is possible to reduce the amount of computation compared to an existing object detection method of determining a moving or static state for all objects. In particular, by reducing an object detection error in a road boundary region, it is possible to improve the confidence of road boundary information.

Hereinafter, a vehicle LiDAR system and an object detection method thereof according to embodiments will be described with reference to the drawings.

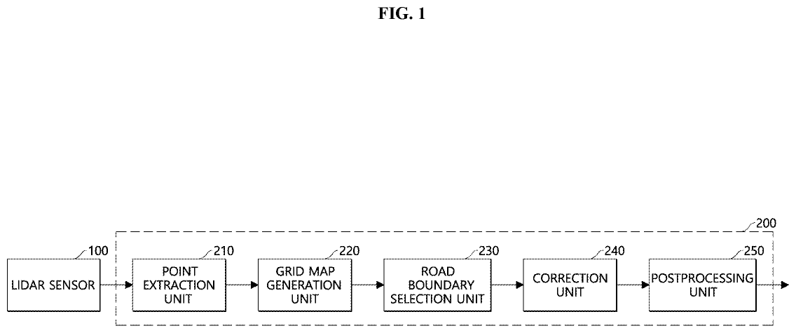

FIG. 1 is a control block diagram of a vehicle LiDAR system according to an embodiment. The vehicle LiDAR system may include a LiDAR sensor 100, and a LiDAR signal processing device 200 which processes data inputted from the LiDAR sensor 100 to output road boundary information. In one embodiment, the outputted road boundary information may be used for controlling a host vehicle.

After irradiating a laser pulse to an object within a measurement range, by measuring a time during which the laser pulse reflected from the object returns, the LiDAR sensor 100 may sense information such as a distance to the object, a direction of the object, a speed, and so forth. The object may be another vehicle, a person, a thing, etc. existing outside the host vehicle. The LiDAR sensor 100 outputs point cloud data (or ‘LiDAR data’) composed of a plurality of points for a single object.

The LiDAR signal processing device 200 may recognize an object by receiving LiDAR data, may track the recognized object, and may classify the type of the corresponding object. The LiDAR signal processing device 200 of the present embodiment may determine the positions of left and right boundaries of a road on which a vehicle is traveling, by using point cloud data inputted from the LiDAR sensor 100. The LiDAR signal processing device 200 may include a point extraction unit 210, a grid map generation unit 220, a road boundary selection unit 230, a correction unit 240, and a postprocessing unit 250.

According to an exemplary embodiment of the present disclosure, the LiDAR signal processing device 200 may include a processor (e.g., computer, microprocessor, CPU, ASIC, circuitry, logic circuits, etc.) and an associated non-transitory memory storing software instructions which, when executed by the processor, provides the functionalities of the point extraction unit 210, the grid map generation unit 220, the road boundary selection unit 230, the correction unit 240, and the postprocessing unit 250. Herein, the memory and the processor may be implemented as separate semiconductor circuits. Alternatively, the memory and the processor may be implemented as a single integrated semiconductor circuit. The processor may embody one or more processor(s).

The point extraction unit 210 of the LiDAR signal processing device 200 extracts point data, necessary to detect road boundaries, from the freespace point data of the LiDAR sensor 100. To this end, the point extraction unit 210 extracts point data of a region-of-interest (ROI) from freespace point data. The freespace point data includes data on all objects except a road surface among objects detected by the LiDAR sensor 100. Accordingly, it is possible to extract point data of the ROI in order to reduce unnecessary computational load. The ROI may be set as a region within 20 m in a longitudinal direction and a lateral direction, and may be adjusted to various sizes depending on a system setting. The point extraction unit 210 deletes a point which does not match a tracking channel among point data in the ROI, that is, a point that does not match an object, and extracts freespace points which are maintained and remain when the matched tracking channel is a static object.

The grid map generation unit 220 of the LiDAR signal processing device 200 generates a grid map by reflecting points extracted by the point extraction unit 220.

The road boundary selection unit 230 of the LiDAR signal processing device 200 may set lane grids according to a lane width on the grid map to select road boundary lane candidates, and then, may divide lane grids selected as the road boundary lane candidates by ‘n’ (‘n’ is a natural number) to set freespace grids so as to select road boundaries.

The road boundary selection unit 230 sets the lane grids according to the lane width. For example, a total of 17 lane grids may be set on left and right sides including a host vehicle lane, and a total of 400 grids may be set for 40 m in front and rear directions with respect to a host vehicle. A lane grid width may be set to about 3 m to 3.5 m in conformity with the lane width of a real road. The road boundary selection unit 230 may assign lane grid numbers of 0 to 17 to the 17 lane grids, respectively.

The road boundary selection unit 230 accumulates tracking channels which match the respective lane grids, in order to select road boundary candidates. A channel may mean a unit by which history information for one object is preserved. The road boundary selection unit 230 may select a road boundary candidate by calculating the ratio of a length occupied by an object to the total length of a lane grid and by calculating, for a lane grid in which the ratio of the length occupied by the object is equal to or greater than a reference, the ratio of a length occupied by a static object to the length occupied by the object. In order to calculate the ratio of the length occupied by the object to the total length of the lane grid, the road boundary selection unit 230 may calculate the sum of the numbers of grids occupied by objects in a corresponding lane. For example, by calculating the percentage of the sum of grids occupied by objects among the 400 grids set in the longitudinal direction in a lane, the occupation percentage of the objects may be calculated. In this regard, it is also possible to perform calculation by setting different weight values to a grid occupied by a static object and a grid occupied by a moving object. The road boundary selection unit 230 may calculate the occupation percentage of a static object by calculating the percentage of a length occupied by the static object to the total length occupied by objects, for lane grids in which the occupation percentage of the objects is equal to or greater than a threshold. When the occupation percentage of the static object is equal to or greater than a predetermined reference, the possibility for a static object to exist in the corresponding lane is high, and thus, a corresponding lane grid may be selected as a road boundary candidate.

The road boundary selection unit 230 selects road boundaries by determining again the distribution of freespace points for lane grids selected as road boundary candidates. The road boundary selection unit 230 sets freespace grids by dividing again a lane grid determined as a road boundary candidate by 3. That is to say, three freespace grids may be set in one lane grid. The road boundary selection unit 230 generates a histogram by counting the number of freespace point data for each freespace grid. The road boundary selection unit 230 selects, as a road boundary candidate, a freespace grid among the freespace grids, in which the number of freespace point data is measured to be equal to or greater than the threshold. Thereafter, the road boundary selection unit 230 selects freespace grids on both sides which are closest to a host vehicle lane among freespace grids selected as road boundary candidates, as the road boundaries.

The correction unit 240 of the LiDAR signal processing device 200 corrects road boundary information selected at a current time point (t), based on road boundary information selected at a previous time point (t-1) and a history of road boundary information, and then updates corrected road boundaries as road boundaries at the current time point (t). The correction unit 240 checks whether there are road boundary output information of the previous time point (t-1) and a road boundary candidate at the current time point (t), and predicts a current position of a road boundary determined at the previous time point (t-1) based on the lateral speed of a host vehicle. The correction unit 240 compares a predicted value and a measurement value at the current time point (t) to calculate whether the predicted value is within a lane range, and corrects a lateral position by using past information when determining an associated road boundary. An equation for correction is as follows.

X_{Lat}=Xₜ₋₁+(1−α)Xₜ <Equation for road boundary correction>

Xt-1: Lateral position of a road boundary at a previous time point (t-1)

Xt: Lateral position of a road boundary at a current time point (t)

α: Lateral position correction coefficient

XLat: Final road boundary lateral position

When the above correction process is completed, corrected road boundaries are updated as road boundaries at the current time point (t).

The postprocessing unit 250 of the LiDAR signal processing device 200 initializes road boundary information when a road boundary determined at a current time point invades a host vehicle lane or when a static object does not exist at a position determined as a road boundary. When a road boundary invades a host vehicle lane or a static object does not exist at a corresponding position may be a situation where a host vehicle rapidly rotates or a road boundary does not exist. Accordingly, the postprocessing unit 250 may initialize road boundary information, and then, may select road boundaries again. For an uninitialized road boundary, that is, a road boundary determined to be valid, the postprocessing unit 250 generates road boundary information, and calculates the confidence of the road boundary information according to the type of a road. The postprocessing unit 250 may calculate and then output information on road boundaries positioned on the left and right sides of the host vehicle and information on confidence of each road boundary. Confidence of road boundary information may be set to Level 0 to Level 3. Level 3 as highest confidence information may be set when a road boundary is normally updated. Level 2 as confidence information lower than Level 3 may be set when new tracking information is generated, and Level 1 may be set when there is no road boundary determined by freespace points but information of a previous time point (t-1) is maintained. A default value of confidence information may be set to Level 0.

As described above, the LiDAR signal processing device 200 of the present embodiment may select a lane in which the number of static objects is equal to or greater than a predetermined number and the occupation percentage of objects in the corresponding lane is equal to or greater than a threshold, as a road boundary candidate, by using a lane grid map, may set freespace lanes by subdividing each of lanes selected as road boundary candidates, and may determine freespace lanes on both sides whose freespace point data are equal to or greater than a reference and which are closest to the host vehicle, as road boundaries.

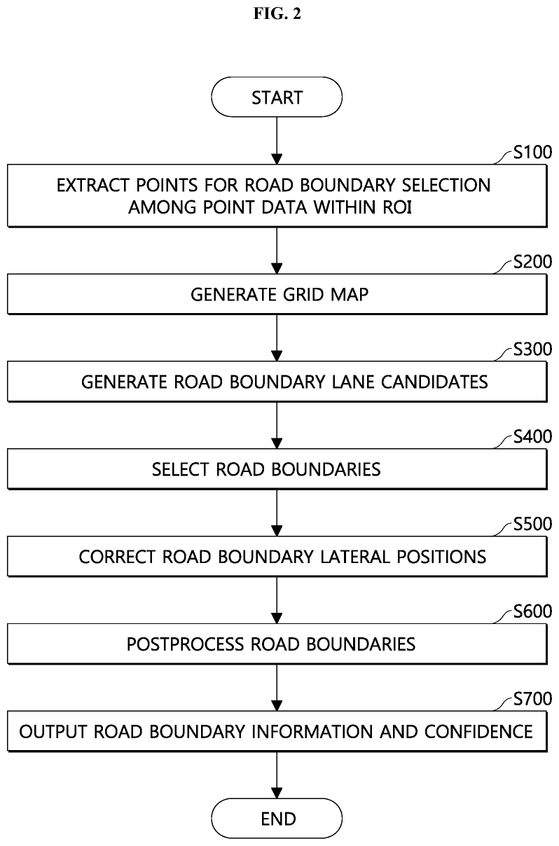

FIG. 2 is a flowchart of an object detection method of a vehicle LiDAR system according to an embodiment, and shows a method of detecting road boundaries by using LiDAR data.

According to the embodiment, in order to detect road boundaries, point data of an ROI are selected among freespace point data of the LiDAR sensor 100, and by deleting points to which a tracking channel is not matched among the point data in the ROI and maintaining point data which are determined to be a static object, the remaining freespace point data are extracted (S100).

A grid map is generated by reflecting the extracted point data (S200).

Lane grids according to a lane width are set in the grid map, and a road boundary lane candidate is selected based on the number of static objects for each lane and the sum of lengths of objects occupying the lane (S300). The road boundary lane candidate may be selected by calculating the ratio of a length occupied by an object to an overall length of a lane grid and the ratio of a length occupied by a static object to an overall length occupied by objects.

Freespace grids are set by dividing a lane grid determined as a road boundary lane candidate by 3 again, and, based on the number of freespace point data measured in each freespace grid and the position of the corresponding freespace grid, a road boundary is selected (S400).

The lateral position of road boundary information selected in a current time point (t) is corrected based on road boundary information selected in a previous time point (t-1) and a history of road boundary information (S500).

The validity of a determined road boundary is verified, road boundary information is postprocessed by calculating the road boundary information and confidence (S600), and then, the road boundary information and the confidence are outputted (S700).

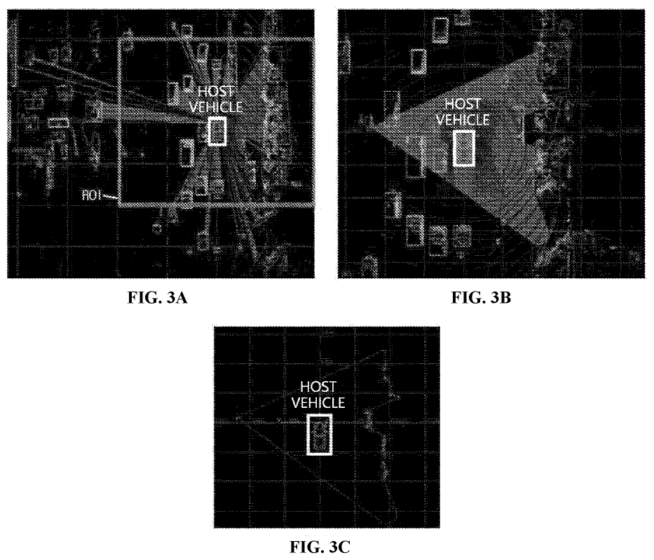

The respective steps of the above method of detecting road boundaries using LiDAR data will be described below in detail with reference to FIGS. 3 to 9.

FIGS. 3A, 3B and 3C are diagrams for explaining a grid map generation method according to an embodiment.

FIG. 3A is a diagram illustrating freespace data of the LiDAR sensor 100, FIG. 3B is a diagram illustrating point data of an ROI, FIG. 3C is a diagram illustrating a grid map generated according to the embodiment.

Referring to FIG. 3A, freespace data includes all point data except a road surface among point cloud data detected through the LiDAR sensor 100 of the host vehicle. Since the freespace data includes data of all sensed regions, point data of an ROI may be extracted in order to reduce unnecessary computational load. The ROI may be set as a region within 20 m in a longitudinal direction and a lateral direction of the host vehicle.

FIG. 3B is a diagram illustrating only point data in the ROI extracted from the freespace data. In the embodiment, by deleting points to which a tracking channel is not matched among the point data in the ROI and maintaining point data determined to be a static object, the remaining freespace point data is extracted to be used for road boundary detection.

FIG. 3C is a diagram illustrating a grid map generated by reflecting the point data extracted from the point data in the ROI of FIG. 3B. As shown in FIG. 3C, point data of objects which are matched to channels among the freespace point data in the ROI may be reflected in the grid map.

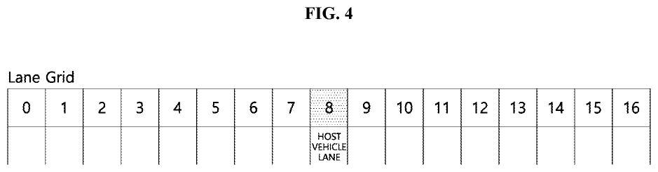

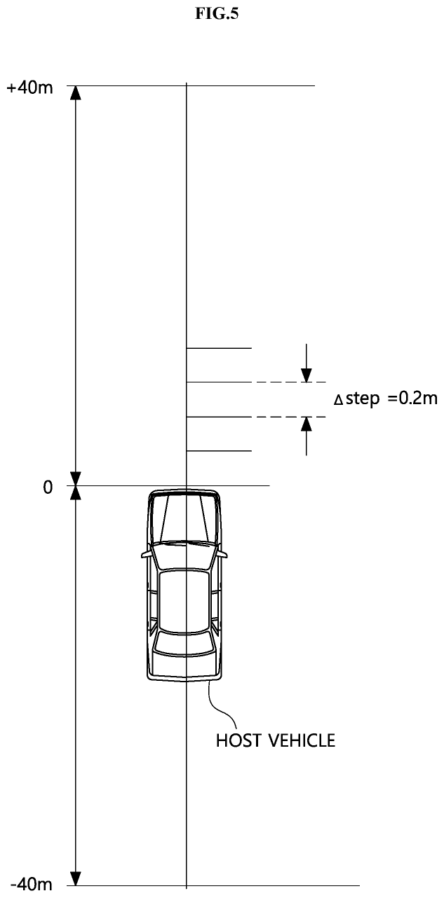

FIGS. 4 and 5 are diagrams for explaining a grid setting method for selecting a road boundary lane candidate according to an embodiment. FIG. 4 is a diagram illustrating an example of setting lane grids in a lateral direction of a host vehicle, and FIG. 5 is a diagram illustrating an example of setting grids in a longitudinal direction.

Referring to FIG. 4, in order to select a road boundary candidate, a lane grid according to a lane width may be set. A plurality of lane grids may be set in the left and right directions of a host vehicle lane. FIG. 4 illustrates a case where a total of 17 lane grids are set by setting eight lanes in the left direction of the host vehicle lane and eight lanes in the right direction of the host vehicle lane. Lane grid numbers 0 to 16 may be assigned to the lane grids, respectively. A lane grid width may be set to about 3 m to 3.5 m in conformity with the lane width of a real road.

Referring to FIG. 5, longitudinal grids may be set up to 40 m in the front and rear directions of the host vehicle. The length of the longitudinal grid may be set according to a resolution for object recognition. When a resolution is high, the length of the grid may be shortened, and when a resolution is low, the length of the grid may be lengthened. FIG. 5 illustrates a case where one grid is set to 0.2 m. When the grid is set to 0.2 m in the longitudinal direction, 200 grids may be set in a front section of 40 m and 200 grids may be set in a rear section of 40 m so that a total of 400 grids may be set in the longitudinal direction.

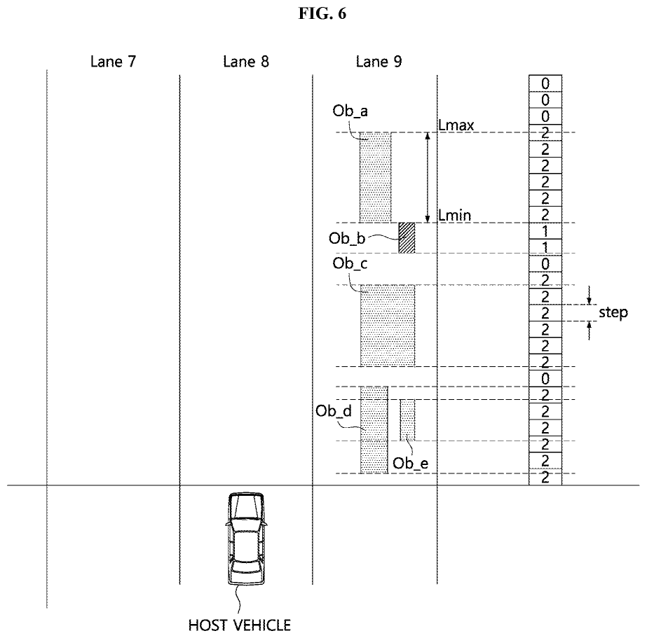

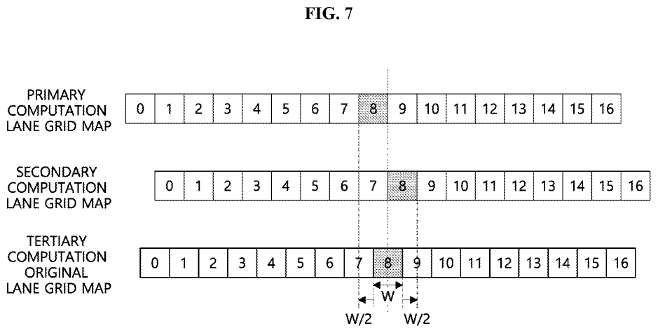

FIGS. 6 and 7 are diagrams for explaining a road boundary lane candidate selection method according to an embodiment. According to the embodiment, objects matching each lane grid may be accumulated in order to select a road boundary candidate, and a road boundary candidate may be selected according to the number of static objects for each lane and the lane occupation percentage of the static objects.

FIG. 6 is a diagram for explaining a method of calculating the lane occupation percentage of an object, and shows an example of calculating the occupation percentage of an object in a lane (lane grid number 9) beside a driving lane (lane grid number 8) of the host vehicle.

FIG. 6 shows a case where five objects Ob_a, Ob_b, Ob_c, Ob_d and Ob_e are matched to the position of the lane grid number 9, and thereamong, the objects Ob_a, Ob_c, Ob_d and Ob_e are static objects and the object Ob_b is a moving object.

Based on one lane grid, when the number of static objects on the corresponding lane grid is equal to or greater than a reference number, for example, 4, the percentage of the length of channels occupied by objects in the corresponding lane grid and the percentage of the length occupied by the static objects to the length of the occupied channels may be calculated.

200 grids are set in the front 40 m section of the lane grid number 9, and 200 grids are set in the rear 40 m section of the lane grid number 9. Accordingly, one grid may be matched to one channel while having a length of 0.2 m.

A channel value may be assigned to each grid according to whether an object occupies the grid and the property of the object occupying the grid. A grid in which no object exists may be assigned a channel value of “0,” a grid which is occupied by an object may be assigned a channel value of “1,” and a grid which is occupied by a static object may be assigned a channel value of “2.” Therefore, a grid which is occupied by the moving object Ob_b may be assigned the channel value of “1,” and grids which are occupied by the static objects Ob_a, Ob_c, Ob_d and Ob_e may be assigned the channel value of “2.”

A sum N_{total valid} of values of channels in each of which a channel value is greater than “0,” that is, an object is detected, may be calculated as the number of grids which are assigned 1 or 2, and by multiplying the sum N_{total valid} by a length Δstep of each grid, a total length L_{total length} of grids occupied by objects may be calculated.

By multiplying a sum N_{static valid} of values of channels each of which has the channel value of “2,” that is, which are occupied by the static objects Ob_a, Ob_c, Ob_d and Ob_e, by the length Δstep of each grid, a length L_{static length} of the grids occupied by the static objects Ob_a, Ob_c, Ob_d and Ob_e, that is, the total length of the static objects Ob_a, Ob_c, Ob_d and Ob_e, may be calculated.

When the percentage of the total length L_{total length} of grids occupied by objects to a total length Total channel Length of a corresponding lane grid is equal to or greater than a reference and the percentage of the length L_{static length} of grids occupied by static objects to the total length L_{total length} of grids occupied by objects is also equal to or greater than a reference, the corresponding lane grid may be selected as a road boundary lane candidate.

This may be expressed as a mathematical algorithm as follows.

if channel value>0, then N_{total valid} is ΣValid total Number L_{total length}=N_{total valid}×Δstep

if channel value=2, then N_{static valid} is ΣValid static Number L_{static length}=N_{static valid}×Δstep

$${δ}_{length occupancy} = \frac{{L}_{total length}}{Total channel Length} \times 100$$

$${δ}_{static occupancy} = \frac{{L}_{static length}}{{L}_{total length}} \times 100$$

$${C}_{threshold} = 60$$

if(δ_{length occupancy}>C_{threshold})And(δ_{static occupancy}>C_{threshold}), then boundary condition meets.

C_{threshold} is a reference value for occupation percentage, and 60% is set as the reference value in the above algorithm. In other words, when the percentage of the length L_{total length} occupied by objects to the total length Total channel length of a lane grid is equal to or greater than 60% and the percentage of the length L_{static length} occupied by static objects to the length L_{total length} occupied by objects is equal to or greater than 60%, the corresponding lane grid may be selected as a road boundary lane candidate.

Meanwhile, a phenomenon in which a tracking channel of one static object is divisionally matched to two adjacent lane grids depending on the position and angle of the static object may occur. For example, when an object having a long length is positioned at a predetermined angle with respect to the extending direction of a lane grid, one partial region and the remaining region thereof may be divisionally matched to adjacent grids, respectively. Because the occupation percentage of an object is calculated in the unit of lane grid, when regions occupied by one object are accumulated in different lane grids, respectively, an error may occur in selecting a road boundary lane candidate. Accordingly, by performing, a multitude of times, a process of moving the position of a lane grid in a left/right direction and then calculating the occupation percentage of static objects through matching of the channels of objects and by selecting a road boundary lane candidate through synthesizing calculation results, accuracy may be improved when selecting a road boundary lane candidate.

FIG. 7 is a diagram for explaining a method of improving accuracy when selecting a road boundary lane candidate.

Referring to FIG. 7, in order to increase the accuracy of selecting a road boundary lane candidate, after moving a lane grid in the left direction and the right direction based on a reference lane grid map, the ratio of the occupation length of static objects to the occupation length of objects in each line may be calculated. The movement width of a lane grid may be variously set. For example, when the width of a lane is W, the lane grid may be moved by W/2 in the left and right directions. Namely, when the width of a lane grid is 3 m, by moving the lane grid by 1.5 m in the left and right directions, the ratio of the occupation length of static objects to the occupation length of objects may be calculated.

In a primary computation, after moving a lane grid in the left direction by W/2 based on a reference lane grid map, the ratio of the length occupied by static objects to the length occupied by objects in each lane may be calculated.

In a secondary computation, after moving the lane grid in the right direction by W/2 based on the reference lane grid map, the ratio of the length occupied by static objects to the length occupied by objects in each lane may be calculated.

In a tertiary computation, in each lane of the reference lane grid map, the ratio of the length occupied by static objects to the length occupied by objects may be calculated.

Thereafter, a road boundary lane candidate may be selected by synthesizing results of the primary, secondary and tertiary computations. For example, a road boundary lane candidate may be selected by synthesizing computation results using various computation methods, such as summing or averaging results calculated for respective lane grids.

When a road boundary lane candidate is selected according to the above process, a road boundary may be selected by comparing distributions of freespace points through further subdividing a corresponding lane.

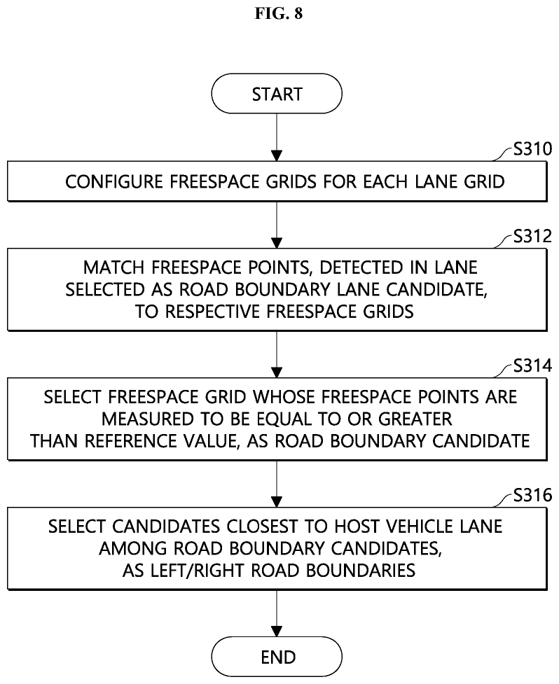

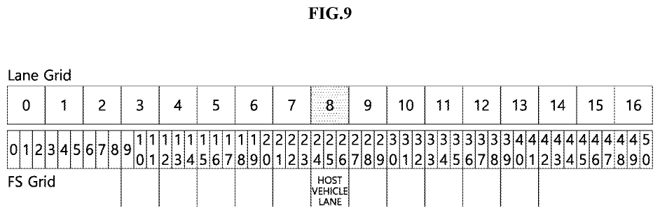

FIGS. 8 and 9 are diagrams for explaining a road boundary selection method according to an embodiment. FIG. 8 is a flowchart of the road boundary selection method, and FIG. 9 is a diagram illustrating a freespace grid.

Referring to FIG. 8, in order to compare distributions of freespace points, freespace grids may be set by dividing each lane grid by 3 again (S310). As illustrated in FIG. 9, when a total of 17 lane grids are set on left and right sides including a host vehicle lane, a total of 51 freespace grids 0 to 50 may be set.

Thereafter, freespace points detected in a lane selected as a road boundary lane candidate are matched to respective freespace grids (S312).

Among the freespace grids, a freespace grid in which the number of freespace point data is measured to be equal to or greater than a threshold may be selected as a road boundary candidate (S314). A histogram may be generated by counting the number of freespace point data for each freespace grid.

Thereafter, the road boundary selection unit 230 selects freespace grids on both sides which are closest to a host vehicle lane among freespace grids selected as road boundary candidates, as road boundaries (S316).

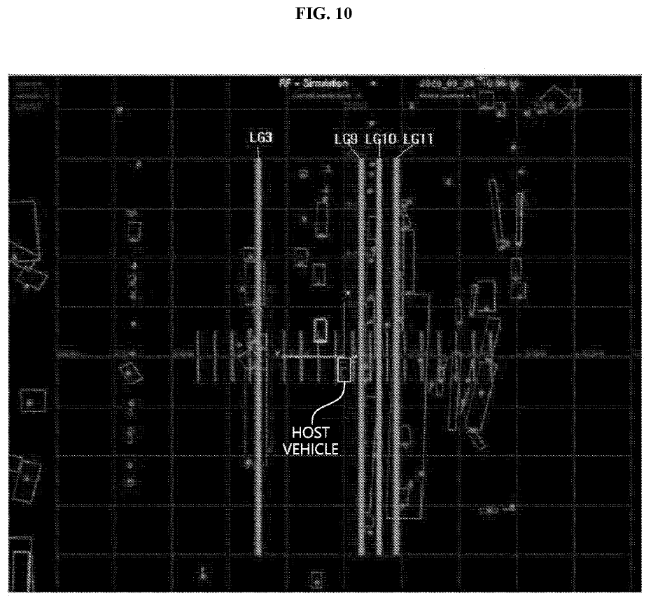

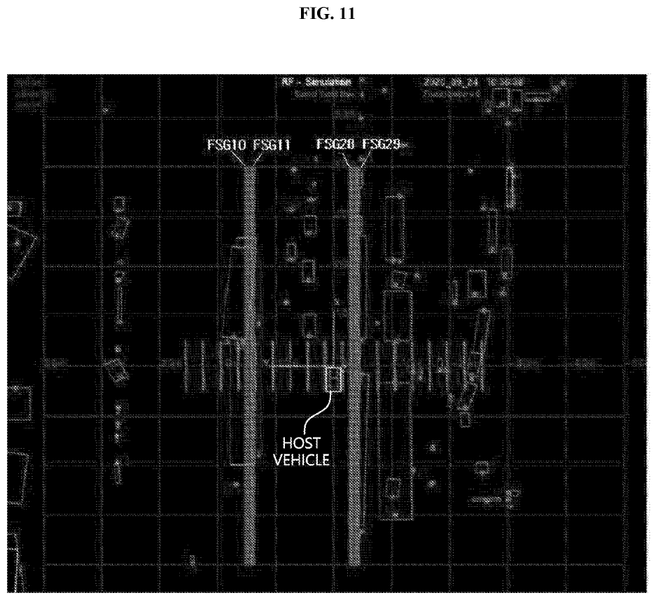

FIGS. 10 and 11 are diagrams showing a result of simulating a road boundary detection method according to an embodiment. FIG. 10 shows a result of selecting road boundary lane candidates, and FIG. 11 shows a result of selecting road boundary candidates.

FIG. 10 shows a simulation result in which lane grid numbers LG (lane grid) 3, LG 9, LG 10 and LG 11 are selected as road boundary lane candidates. Referring to FIG. 10, road boundary candidates may be set based on lane grids set in the left and right directions of a host vehicle lane. Lane grid numbers 0 to 16 may be assigned to the lane grids, respectively. Accordingly, a lane grid number where a host vehicle is positioned may be set as LG 8. A road boundary lane candidate may be selected according to the number of static objects and the lane occupation percentage of the static objects, for each lane.

FIG. 11 shows a simulation result in which freespace grid numbers FSG (freespace grid) 10, FSG 11, FSG 28 and FSG 29 are selected as road boundary candidates. The road boundary candidates FSG 10, FSG 11, FSG 28 and FSG 29 may be selected by subdividing LG 3, LG 9, LG 10 and LG 11 selected as road boundary lane candidates and comparing distributions of freespace point data. Freespace grids are set to numbers 0 to 50 by dividing each lane grid by 3. Accordingly, FSG 9, FSG 10 and FSG 11 are set in the road boundary lane candidate LG 3, FSG 27, FSG 28 and FSG 29 are set in the road boundary lane candidate LG 9, FSG 30, FSG 31 and FSG 32 are set in the road boundary lane candidate LG 10, and FSG 33, FSG 34 and FSG 35 are set in the road boundary lane candidate LG 11. Among these freespace grids, a freespace grid in which the number of freespace point data is equal to or greater than a threshold may be selected as a road boundary candidate. FIG. 11 illustrates that the freespace grids FSG 10, FSG 11, FSG 28 and FSG 29 are selected as road boundary candidates.

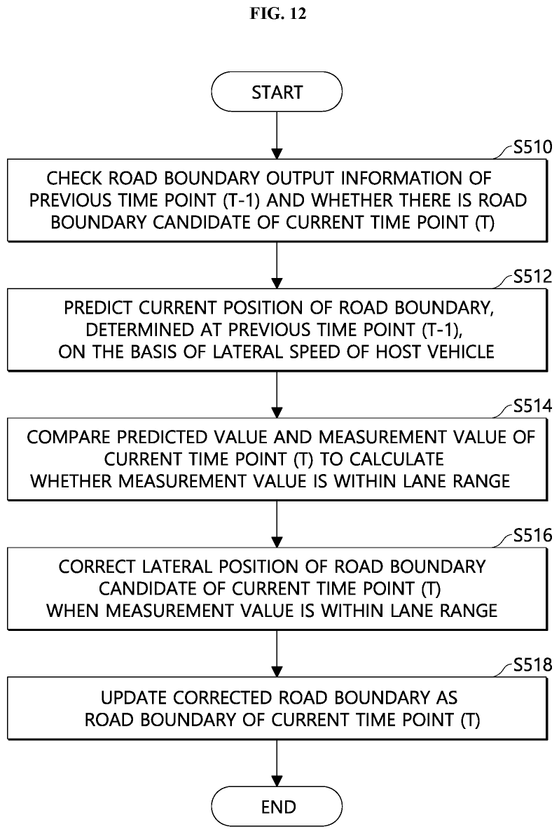

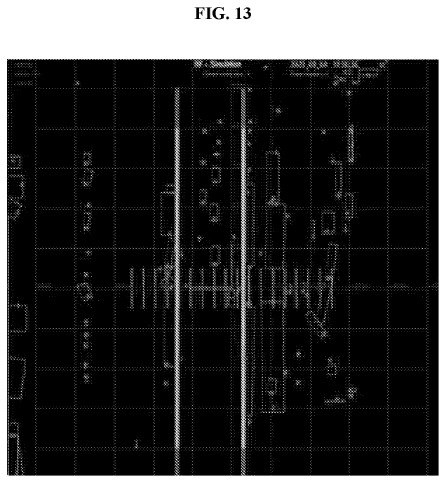

FIGS. 12 and 13 are diagrams for explaining a road boundary selection method. FIG. 12 is a flowchart of a lateral correction method for road boundary selection, and FIG. 13 is a diagram showing finally determined road boundaries.

Final road boundaries may be determined by selecting freespace grids closest to the left and right sides of a host vehicle among road boundary candidates and thereafter correcting lateral positions thereof and performing a postprocessing process.

Referring to FIG. 12, in order for lateral position correction, it is checked whether there are road boundary output information of a previous time point t-1 and a road boundary candidate at a current time point t (S510), and a current position of a road boundary determined at the previous time point t-1 is predicted based on the lateral speed of a host vehicle (S512).

The predicted value and a measurement value of the current time point t are compared to calculate whether the measurement value is within a lane range (S514). When it is checked that the measurement value is within the lane range, the measurement value of the current time point t may be corrected such that the measurement value of the current time point t is smoothly connected with a road boundary value selected at the previous time point t-1 (S516).

When correction is completed, a corrected road boundary is updated as a road boundary of the current time point t (S518). FIG. 13 shows a result of simulating a road boundary which is finally updated.

Thereafter, when an updated road boundary invades a host vehicle lane or a static object does not exist at a position determined as a road boundary, road boundary information is initialized and postprocessed, and when the postprocessing is completed, position information and confidence of a road boundary may be assigned and outputted.

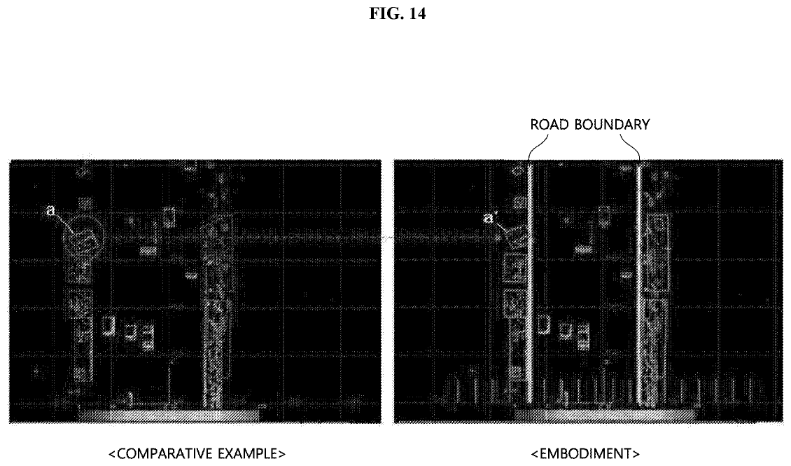

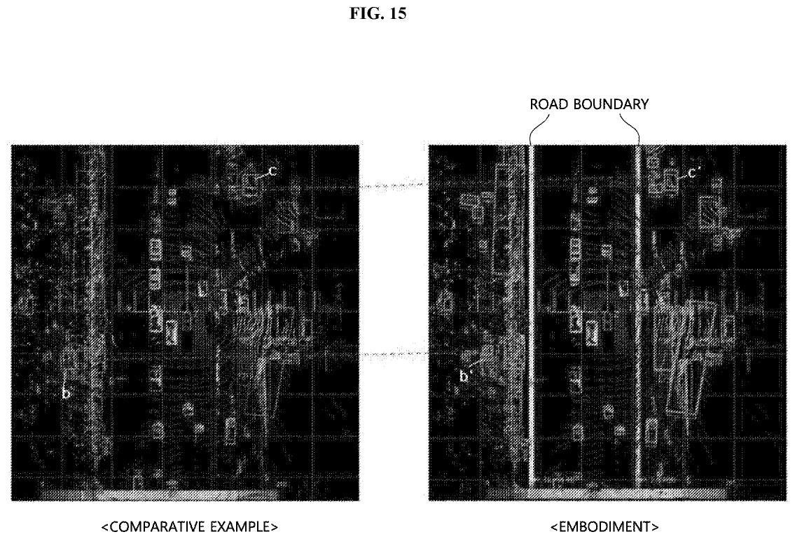

FIGS. 14 and 15 are diagrams showing simulation results according to comparative examples and embodiments.

Referring to FIG. 14, <Comparative Example> shows a signal processing result of a LiDAR system which does not determine a road boundary, and <Embodiment> as a signal processing result of a LiDAR system which determines a road boundary shows a result of simulating a case where a vehicle is traveling on a highway. In <Comparative Example>, since a road boundary is not determined, an object outside a road boundary, which does not influence the driving of a vehicle, is recognized as a moving object a. On the other hand, in the case of <Embodiment>, since a road boundary is determined, it is possible to determine an object outside a road boundary as a static object a′. Accordingly, it is possible to prevent unnecessary computation from being performed to track a moving object outside a road boundary, which does not influence the driving of a vehicle.

Referring to FIG. 15, <Comparative Example> shows a signal processing result of a LiDAR system which does not determine a road boundary, and <Embodiment> as a signal processing result of a LiDAR system which determines a road boundary shows a result of simulating a case where a vehicle travels on a city road. In <Comparative Example>, since a road boundary is not determined, objects outside road boundaries, which do not influence the driving of a vehicle, are recognized as moving objects b and c. On the other hand, in the case of <Embodiment>, since a road boundary is determined, it is possible to determine objects outside road boundaries as static objects b′ and c′. Accordingly, it is possible to prevent unnecessary computation from being performed to track a moving object outside a road boundary, which does not influence the driving of a vehicle.

As is apparent from the above description, the present embodiments suggest a method of determining the positions of left and right boundaries of a road on which a host vehicle is traveling, by using information on point data of a freespace and an object. Accordingly, by determining an object outside the boundary of a road as a static state, it is possible to reduce the amount of computation compared to an existing object detection method. In particular, by reducing an object detection error in a road boundary region, it is possible to improve the confidence of road boundary information.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An object detection method of a vehicle LiDAR system, comprising:
setting grids including a host vehicle lane according to a lane width on a grid map which is generated based on freespace point data and object information, and calculating a road boundary candidate based on occupation percentages of objects by lane calculated based on the object information and distributions of the freespace point data; and
outputting road boundary information by correcting the calculated road boundary candidate based on information on a road boundary candidate determined at a previous time point.

2. The object detection method of claim 1, wherein the calculating of the road boundary candidate comprises:
extracting point data of a region-of-interest from the freespace point data;
deleting points which are not matched to an object, among the extracted point data in the region-of-interest; and
generating the grid map based on freespace point data remaining after deleting the points which are not matched to the object.

3. The object detection method of claim 1, wherein the calculating of the road boundary candidate comprises:
selecting a road boundary lane candidate by setting lane grids including the host vehicle lane according to the lane width on the grid map; and
selecting the road boundary candidate by setting freespace grids which are obtained by dividing a lane selected as the road boundary lane candidate by ‘n’, wherein ‘n’ is a natural number.

4. The object detection method of claim 3, wherein the selecting of the road boundary lane candidate comprises:
matching object tracking channels to each lane grid of the lane grids;
calculating a ratio of a length occupied by objects to an overall length of each lane grid;
calculating a ratio of a length occupied by static objects to the length occupied by the objects, for a lane grid in which the ratio of the length occupied by the objects is equal to or greater than a first reference; and
selecting a corresponding lane grid from the lane grids as the road boundary lane candidate when the ratio of the length occupied by the static objects to the length occupied by the objects is equal to or greater than a second reference.

5. The object detection method of claim 4, wherein the calculating of the ratio of the length occupied by objects to the overall length of the lane grid comprises:
assigning different weights to a grid occupied by a static object and a grid occupied by a moving object, respectively, for longitudinal grids set in the lane grid in which the ratio of the length occupied by the objects is equal to or greater than the first reference, and summing values of grids occupied by the objects; and
calculating a percentage of a value obtained by summing the values of the grids occupied by the objects to a total number of longitudinal grids set in the lane grid.

6. The object detection method of claim 4, wherein the selecting of the road boundary lane candidate comprises:
moving a position of the lane grid in left and right directions;
calculating a ratio of a length occupied by static objects to a length occupied by objects based on the moved lane grid; and
calculating a ratio of a length occupied by static objects calculated based on the moved lane grid to a length occupied by static objects calculated before the lane grid is moved, and when the ratio of the length occupied by the static objects is equal to or greater than a third reference, selecting the corresponding lane grid as the road boundary lane candidate.

7. The object detection method of claim 3, wherein the selecting of the road boundary candidate comprises:
setting freespace grids by dividing a lane grid of the lane selected as the road boundary lane candidate by 3;
measuring the number of freespace point data belonging to each freespace grid of the set freespace grids; and
selecting a freespace grid of which the measured number of freespace point data is equal to or greater than a threshold, as the road boundary candidate.

8. The object detection method of claim 7, wherein the outputting of the road boundary information comprises:
calculating a predicted value of a road boundary at a current time point by reflecting a lateral speed of the host vehicle on the information on the road boundary candidate determined at the previous time point;
selecting left and right freespace grids adjacent to the host vehicle among road boundary candidates including the road boundary candidate; and
outputting the road boundary information by correcting the selected freespace grids according to the predicted value.

9. The object detection method of claim 8, further comprising
initializing the road boundary information when the corrected road boundary invades the host vehicle lane or there is no static object at a position of the corrected road boundary.

10. The object detection method of claim 1, further comprising
obtaining, by a LiDAR sensor, the freespace point data and the object information before the setting of the grids.

11. A non-transitory computer-readable recording medium storing a program for executing an object detection method of a vehicle LiDAR system, wherein execution of the program causes a processor to:
set grids including a host vehicle lane according to a lane width on a grid map which is generated based on freespace point data and object information, and calculate a road boundary candidate based on occupation percentages of objects by lane calculated based on the object information and distributions of the freespace point data; and
output road boundary information by correcting the calculated road boundary candidate based on information on a road boundary candidate determined at a previous time point.

12. A vehicle LiDAR system comprising:
a LiDAR sensor configured to obtain freespace point data and object information; and
a LiDAR signal processing device configured to set lane grids including a host vehicle lane according to a lane width on a grid map which is generated based on the freespace point data and the object information obtained through the LiDAR sensor, to calculate a road boundary candidate based on occupation percentages of objects by lane calculated based on the object information and distributions of the freespace point data, and to output road boundary information by correcting the calculated road boundary candidate based on information on a road boundary candidate determined at a previous time point.

13. The vehicle LiDAR system of claim 12, wherein the LiDAR signal processing device comprises:
a point extraction unit configured to extract point data of a region-of-interest from the freespace point data, and to delete points which are not matched to an object, among the extracted point data in the region-of-interest; and
a grid map generation unit configured to generate the grid map based on freespace point data remaining after deleting the points which are not matched to the object.

14. The vehicle LiDAR system of claim 12, wherein the LiDAR signal processing device comprises:
a road boundary selection unit configured to select a road boundary lane candidate by setting lane grids including the host vehicle lane according to the lane width on the grid map, and to select the road boundary candidate by setting freespace grids which are obtained by dividing a lane selected as the road boundary lane candidate by ‘n’, wherein ‘n’ is a natural number.

15. The vehicle LiDAR system of claim 14, wherein the road boundary selection unit matches object tracking channels to each lane grid of the lane grids, calculates a ratio of a length occupied by objects to an overall length of each lane grid, calculates a ratio of a length occupied by static objects to the length occupied by the objects, for a lane grid in which the ratio of the length occupied by the objects is equal to or greater than a first reference, and selects a corresponding lane grid from the lane grids as the road boundary lane candidate when the ratio of the length occupied by the static objects to the length occupied by the objects is equal to or greater than a second reference.

16. The vehicle LiDAR system of claim 15, wherein the road boundary selection unit assigns different weights to a grid occupied by a static object and a grid occupied by a moving object, respectively, for longitudinal grids set in the lane grid in which the ratio of the length occupied by the objects is equal to or greater than the first reference, sums values of grids occupied by the objects, and calculates a percentage of a value obtained by summing the values of the grids occupied by the objects to a total number of longitudinal grids set in the lane grid.

17. The vehicle LiDAR system of claim 15, wherein the road boundary selection unit moves a position of the lane grid in left and right directions, calculates a ratio of a length occupied by static objects to a length occupied by objects based on the moved lane grid, calculates a ratio of a length occupied by static objects calculated based on the moved lane grid to a length occupied by static objects calculated before the lane grid is moved, and when the ratio of the length occupied by the static objects is equal to or greater than a third reference, selects the corresponding lane grid as the road boundary lane candidate.

18. The vehicle LiDAR system of claim 14, wherein the road boundary selection unit sets freespace grids by dividing a lane grid of the lane selected as the road boundary lane candidate by 3, measures the number of freespace point data belonging to each freespace grid of the freespace grids set by the road boundary selection unit, and selects a freespace grid of which the measured number of freespace point data is equal to or greater than a threshold, as the road boundary candidate.

19. The vehicle LiDAR system of claim 18, further comprising:
a correction unit configured to calculate a predicted value of a road boundary at a current time point by reflecting a lateral speed of the host vehicle on the information on the road boundary candidate determined at the previous time point, to select left and right freespace grids adjacent to the host vehicle among road boundary candidates including the selected road boundary candidate, and to output the road boundary information by correcting the selected freespace grids according to the predicted value.

20. The vehicle LiDAR system of claim 19, further comprising:
a postprocessing unit configured to initialize the road boundary information when the corrected road boundary invades the host vehicle lane or there is no static object at a position of the corrected road boundary.
